(19) United States
(12) Patent Application Publication
(10) Pub. No.: US 2026/0067993 A1
(43) Pub. Date: Mar. 5, 2026

(54) ELECTRONIC DEVICE, METHOD, AND NON-TRANSITORY COMPUTER-READABLE STORAGE MEDIUM FOR PROVIDING VOICE SERVICE

(71) Applicant: Samsung Electronics Co., Ltd., Suwon-si (KR)

(72) Inventors: Minh Duc HOANG, Bac Ninh Province (VN); Van Thinh NGUYEN, Bac Ninh Province (VN); Ba Luyen KIEU, Bac Ninh Province (VN); Thi Huyen NGUYEN, Bac Ninh Province (VN); Duc Cuong VU, Bac Ninh Province (VN); Ba Truong NGUYEN, Bac Ninh Province (VN)

(21) Appl. No.: 19/228,078

(22) Filed: Jun. 4, 2025

Related U.S. Application Data
(63) Continuation of application No. PCT/KR2025/007028, filed on May 23, 2025.

(30) Foreign Application Priority Data
Sep. 4, 2024 (KR) 10-2024-0120388

(51) Int. Cl. H04W 76/50; H04W 4/90; H04W 48/18; H04W 84/04

(52) U.S. Cl. CPC H04W 76/50; H04W 4/90; H04W 48/18; H04W 84/042

(57) ABSTRACT

An electronic device including at least one processor is set to identify whether a standalone non-public network (SNPN) supports a voice service, based on a voice service indicator received from the SNPN during a registration procedure for the SNPN, transmit, to a wearable device, a message instructing the wearable device connected to the electronic device through a first radio access technology (RAT) to connect to a network using a public land mobile network (PLMN) in accordance with an identification that the SNPN does not support the voice service, and perform a voice communication with an external electronic device through the wearable device connected to the network.

### CROSS-REFERENCE TO RELATED APPLICATIONS

This application is a continuation of International Application No. PCT/KR2025/007028 designating the United States, filed on May 23, 2025, in the Korean Intellectual Property Receiving Office and claiming priority to Korean Patent Application No. 10-2024-0120388, filed on Sep. 4, 2024, in the Korean Intellectual Property Office, the disclosures of each of which are incorporated by reference herein in their entireties.

### BACKGROUND

### Field

The disclosure relates to an electronic device, a method, and a non-transitory computer-readable storage medium for providing a voice service.

### Description of Related Art

A standalone non-public network (SNPN) refers to a private network configured separately from a public land mobile network (PLMN). The SNPN may not provide at least a portion of services provided by the PLMN.

The above-described information may be provided as a related art for the purpose of helping understanding of the present disclosure. No assertion or determination is raised as to whether any of the above-described descriptions may be applied as a prior art related to the present disclosure.

### SUMMARY

An electronic device is provided. The electronic device may comprise communication circuitry. The electronic device may comprise memory, including one or more storage media, storing instructions. The electronic device may comprise at least one processor including processing circuitry. The instructions, when executed by the at least one processor individually or collectively, may cause the electronic device to identify whether a standalone non-public network (SNPN) supports a voice service based on a voice service indicator received from the SNPN during a registration procedure for the SNPN; transmit, to a wearable device, a message instructing the wearable device connected to the electronic device through a first radio access technology (RAT) to connect to a network using a public land mobile network (PLMN) in accordance with an identification that the SNPN does not support the voice service; and perform a voice communication with an external electronic device through the wearable device connected to the network.

A method is provided. The method may be performed by an electronic device including communication circuitry. The method may comprise: identifying whether a standalone non-public network (SNPN) supports a voice service based on a voice service indicator received from the SNPN during a registration procedure for the SNPN; transmitting, to a wearable device, a message instructing the wearable device connected to the electronic device through a first radio access technology (RAT) to connect to a network using a public land mobile network (PLMN) in accordance with an identification that the SNPN does not support the voice service; and performing a voice communication with an external electronic device through the wearable device connected to the network.

A non-transitory computer-readable storage medium is provided. The non-transitory computer-readable storage medium may store one or more programs. The one or more programs, when executed by at least one processor of an electronic device individually or collectively, may cause the electronic device to: identify whether a standalone non-public network (SNPN) supports a voice service based on a voice service indicator received from the SNPN during a registration procedure for the SNPN; transmit, to a wearable device, a message instructing the wearable device connected to the electronic device through a first radio access technology (RAT) to connect to a network using a public land mobile network (PLMN) in accordance with an identification that the SNPN does not support the voice service; and perform a voice communication with an external electronic device through the wearable device connected to the network.

A wearable device is provided. The wearable device may comprise a display. The wearable device may comprise communication circuitry. The wearable device may comprise memory, including one or more storage media, storing instructions. The wearable device may comprise at least one processor including processing circuitry. The instructions, when executed by the at least one processor individually or collectively, may cause the wearable device to activate an operation mode of the wearable device deactivating a second radio access technology (RAT) for connecting to a network of a public land mobile network (PLMN) while the wearable device is connected to an electronic device using a first RAT; perform a registration procedure for the PLMN based on receiving a message, from the electronic device, instructing the wearable device to connect to the network using the PLMN; and display a visual object for the operation mode of the wearable device deactivating the second RAT through the display based on performing the registration procedure for the PLMN.

A method is provided. The method may be performed by a wearable device comprising a display. The method may comprise: activating an operation mode of the wearable device deactivating a second radio access technology (RAT) for connecting to a network of a public land mobile network (PLMN) while the wearable device is connected to an electronic device using a first RAT; performing a registration procedure for the PLMN based on receiving a message, from the electronic device, instructing the wearable device to connect to the network using the PLMN; and displaying a visual object for the operation mode of the wearable device deactivating the second RAT through the display based on performing the registration procedure for the PLMN.

A non-transitory computer-readable storage medium is provided. The non-transitory computer-readable storage medium may store one or more programs. The one or more programs, when executed by at least one processor of a wearable device individually or collectively, may cause the wearable device to: activate an operation mode of the wearable device deactivating a second radio access technology (RAT) for connecting to a network of a public land mobile network (PLMN) while the wearable device is connected to an electronic device using a first RAT; perform a registration procedure for the PLMN based on receiving a message, from the electronic device, instructing the wearable device to connect to the network using the PLMN; and display a visual object for the operation mode of the wearable device deactivating the second RAT through the display, based on performing the registration procedure for the PLMN.

### BRIEF DESCRIPTION OF THE DRAWINGS

In relation to a description of a drawing, the same or similar reference numerals may be used for the same or similar components. Further, the above and other aspects, features and advantages of certain embodiments of the present disclosure will be more apparent from the following detailed description, taken in conjunction with the accompanying drawings, in which:

FIG. 1 is a diagram illustrating an example of a communication system according to various embodiments;

FIG. 2 is a block diagram illustrating an example configuration of an electronic device and a wearable device according to various embodiments;

FIG. 3 is a flowchart illustrating an example operation of an electronic device for providing a voice service through a wearable device according to various embodiments;

FIG. 4 is a diagram illustrating an example of providing a voice service through a wearable device according to various embodiments;

FIG. 5 is a flowchart illustrating an example operation of an electronic device for performing emergency communication through a wearable device according to various embodiments;

FIG. 6 is a flowchart illustrating an example operation of an electronic device associated with call forwarding according to various embodiments;

FIG. 7 is a flowchart illustrating an example operation of a wearable device for providing a voice service to an electronic device according to various embodiments;

FIG. 8 is a diagram illustrating an example screen of a display of a wearable device providing a voice service to an electronic device according to various embodiments; and

FIG. 9 is a signal flow diagram illustrating example signaling between an electronic device and a wearable device for providing a voice service according to various embodiments.

### DETAILED DESCRIPTION

Terms used in the present disclosure are used simply to describe various example embodiments, and are not intended to limit the disclosure. A singular expression may include a plural expression unless the context clearly means otherwise. Terms used herein, including a technical or a scientific term, may have the same meaning as those generally understood by a person with ordinary skill in the art described in the present disclosure. Among the terms used in the present disclosure, terms defined in a general dictionary may be interpreted as identical or similar meaning to the contextual meaning of the relevant technology and are not interpreted as ideal or excessively formal meaning unless explicitly defined in the present disclosure. In some cases, even terms defined in the present disclosure may not be interpreted to exclude embodiments of the present disclosure.

In various embodiments of the present disclosure described below, a hardware approach will be described as an example. However, since the various embodiments of the present disclosure include technology that uses both hardware and software, the various embodiments of the present disclosure do not exclude a software-based approach.

In addition, in the present disclosure, the term ‘greater than’ or ‘less than’ may be used to determine whether a particular condition is satisfied or fulfilled, but this is merely a description to express an example and does not exclude description of ‘greater than or equal to’ or ‘less than or equal to’. A condition described as ‘greater than or equal to ’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ may refer, for example, to including at least one of ‘C’or ‘D’, that is, {‘C’, ‘D’, and ‘C’ and ‘D’}.

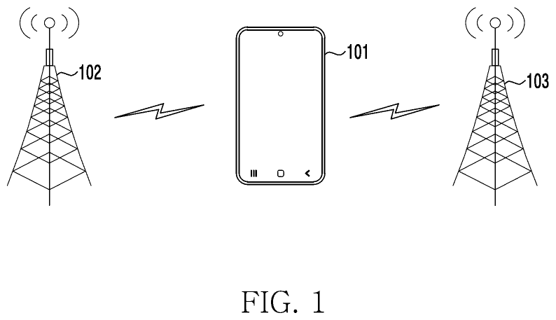

FIG. 1 is a diagram illustrating an example of a communication system according to various embodiments.

Referring to FIG. 1, FIG. 1 illustrates an electronic device 101, a public land mobile network (PLMN) 102, and a standalone non-public network (SNPN) 103 in a communication system.

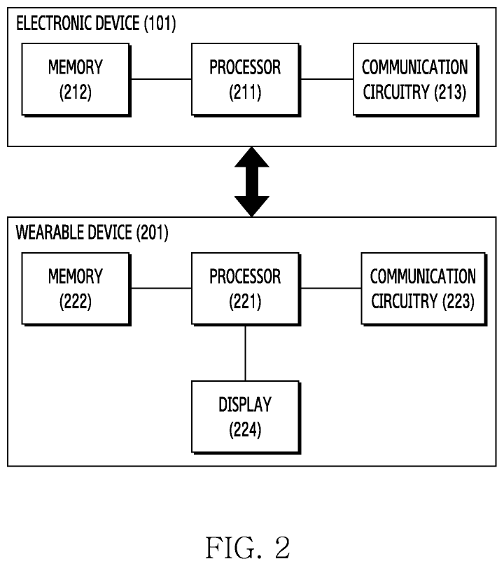

The electronic device 101, which is a device used by a user, may perform communication with a base station of the PLMN 102 through a wireless channel. A link from the base station of the PLMN 102 to the electronic device 101 is referred to as a downlink (DL), and a link from the electronic device 101 to the base station of the PLMN 102 is referred to as an uplink (UL). In addition, although not illustrated in FIG. 1, the electronic device 101 may perform communication through the wireless channel between the electronic device 101 and another electronic device (e.g., a wearable device 201 of FIG. 2). In this case, a device-to-device (D2D) link between the electronic device 101 and the other electronic device is referred to as a sidelink, and the sidelink may be used interchangeably with a PC5 interface. In various embodiments, the electronic device 101 may be operated without user involvement. For example, the electronic device 101, which is a device that performs machine type communication (MTC), may not be carried by the user. In addition, for example, the electronic device 101 may be a narrowband (NB)-internet of things (IoT) device.

The electronic device 101 may be referred to as a ‘terminal’, ‘user equipment (UE), ‘customer premises equipment (CPE)’, a ‘mobile station’, a ‘subscriber station’, a ‘remote terminal’, a ‘wireless terminal’, an ‘electronic device’, or a ‘user device’, or another term having the same technical meaning.

The PLMN 102 refers to a cellular network in which a cellular provider distributes to a specific geographic location. For example, the electronic device 101 may connect to the PLMN 102 based on a subscriber identity module (SIM) profile. For example, a state in which the electronic device 101 is connected to the PLMN 102 may be referred to as a PLMN access mode. For example, the electronic device 101 may receive services from network functions in the PLMN access mode. For example, the electronic device 101 may receive a voice service through the PLMN 102. As an example, the voice service may correspond to an internet protocol multimedia subsystem (IMS) voice over PS session. For example, the electronic device 101 may receive an emergency service through the PLMN 102.

The SNPN 103 refers to a private network configured separately from the PLMN 102. For example, a state in which the electronic device 101 is connected to the SNPN 103 may be referred to as an SNPN access mode. For example, the SNPN 103 may not support the voice service. In another example, the SNPN 103 may support the voice service. For example, the SNPN 103 may not support the emergency service. In another example, the SNPN 103 may support the emergency service.

For example, the electronic device 101 may include dual SIMs. The electronic device 101 including the dual SIMs may be concurrently connected to the PLMN 102 and the SNPN 103. However, the electronic device 101 may include a single SIM. The electronic device 101 including the single SIM may connect to the SNPN 103. When the SNPN 103 does not support the voice (or emergency) service, the electronic device 101 may receive the voice (or emergency) service by disconnecting the connection with the SNPN 103 and connecting with the PLMN 102. However, disconnecting the connection with the SNPN 103 and connecting with the PLMN 102 causes time consumption. Hereinafter, an electronic device, a method, and a non-transitory computer-readable storage media that receive a voice (or emergency) service through interworking with the wearable devices 201 in a state in which the electronic device 101 is connected to the SNPN 103 that does not support the voice (or emergency) service are described.

FIG. 2 is a block diagram illustrating an example configuration of an electronic device and a wearable device according to various embodiments.

Referring to FIG. 2, an electronic device 101 may include a processor (e.g., including processing circuitry) 211, memory 212, and communication circuitry 213. For example, the processor 211, the memory 212, and the communication circuitry 213 may be electronically and/or operably coupled with each other by a communication bus. Hereinafter, hardware components being operably coupled may refer, for example, to a direct connection or an indirect connection between the hardware components being established by wire or wirelessly so that a second hardware component is controlled by a first hardware component among the hardware components. The hardware components illustrated in FIG. 2 are illustrated based on different blocks, but the present disclosure is not limited thereto. A portion (e.g., at least a portion of the processor 211, the memory 212, and/or the communication circuitry 213) of the hardware components of the electronic device 101 illustrated in FIG. 2 may be included in a single integrated circuit such as a system on chip (SoC) or a system in package (SIP). A type and the number of the hardware components included in the electronic device 101 are not limited as illustrated in FIG. 2. For example, the electronic device 101 may include only a portion of the hardware components illustrated in FIG. 2.

In an embodiment, the processor 211 of the electronic device 101 may include a hardware component for processing data based on one or more instructions. The hardware components for processing data may include, for example, an arithmetic and logic unit (ALU), a floating point unit (FPU), and a field programmable gate array (FPGA). As an example, the hardware components for processing data may include a central processing unit (CPU), a graphics processing unit (GPU), a digital signal processing (DSP), a microcontroller (MCU), and/or a neural processing unit (NPU). The number of the processor 211 may be one or more. For example, the processor 211 may have a structure of a multi-core processor such as a dual core, a quad core, or a hexa core.

In an embodiment, the processor 211 may include various processing circuitry and/or a plurality of processors. For example, the term “processor” used in the disclosure, including the scope of claims, may include various processing circuitry including at least one processor, and one or more of the at least one processor may be configured to perform various functions described below individually and/or collectively in a distributed manner. As used below, when “processor”, “at least one processor”, and “one or more processors” are described as being configured to perform various functions, these terms are not limited thereto and include, for example, situations in which one processor performs a portion of cited functions, and another processor(s) performs another portion of the cited functions, and also situations in which one processor can perform all of the cited functions. Additionally, the at least one processor may include, for example, a combination of processors that perform various functions listed/initiated in a distributed manner. The at least one processor may execute program instructions to achieve or perform various functions.

In an embodiment, the memory 212 of the electronic device 101 may include a hardware component for storing data and/or instructions input to the processor 211 and/or output from the processor 211. For example, the memory 212 may include volatile memory such as random-access memory (RAM) and/or non-volatile memory such as read-only memory (ROM). For example, the volatile memory may include at least one of dynamic RAM (DRAM), static RAM (SRAM), Cache RAM, and pseudo SRAM (PSRAM). The non-volatile memory may include, for example, at least one of programmable ROM (PROM), erasable PROM (EPROM), electrically erasable PROM (EEPROM), flash memory, a hard disk, a compact disk, and an embedded multimedia card (eMMC).

In an embodiment, one or more instructions (or commands) indicating a calculation and/or an operation performed by the processor 211 of the electronic device 101 may be stored in the memory 212 of the electronic device 101. A set of the one or more instructions may be referred to as a program, firmware, an operating system, a process, a routine, a sub-routine, and/or an application. Hereinafter, being installed in the electronic device 101 may refer, for example, to one or more instructions provided in a form of the application being stored in the memory 212, and one or more applications are stored in an executable format by the processor 211 of the electronic device 101.

In an embodiment, the communication circuitry 213 of the electronic device 101 may include a circuit for supporting transmission and/or reception of an electrical signal between the electronic device 101 and an external electronic device (e.g., the wearable device 201) different from the electronic device 101. The communication circuitry 213 may include at least one of a modem, an antenna, and an optic/electronic (O/E) converter. The communication circuitry 213 may support the transmission and/or the reception of the electrical signal based on various types of communication means such as Ethernet, Bluetooth, Bluetooth low energy (BLE), ZigBee, long term evolution (LTE), and 5G new radio (NR).

Referring to FIG. 2, the wearable device 201 may include a processor (e.g., including processing circuitry) 221, memory 222, communication circuitry 223, and a display 224. For example, the processor 221, the memory 222, the communication circuitry 223, and the display 224 may be electronically and/or operably coupled with each other by a communication bus. Hereinafter, hardware components being operably coupled may refer, for example, to a direct connection or an indirect connection between the hardware components being established by wire or wirelessly so that a second hardware component is controlled by a first hardware component among the hardware components. The hardware components illustrated in FIG. 2 are illustrated based on different blocks, but the present disclosure is not limited thereto. For example, a portion (e.g., the processor 221, the memory 222, the communication circuitry 223, and/or the display 224) of the hardware components of the wearable device 201 shown in FIG. 2 may be included in a single integrated circuit such as a system on chip (SoC) or a system in package (SIP). A type and the number of the hardware components included in the wearable device 201 are not limited as illustrated in FIG. 2. For example, the wearable device 201 may include only a portion of the hardware components illustrated in FIG. 2.

In an embodiment, the processor 221 of the wearable device 201 may include a hardware component for processing data based on one or more instructions. The hardware component for processing data may include, for example, arithmetic and logic unit (ALU), a floating point unit (FPU), and a field programmable gate array (FPGA). As an example, the hardware component for processing data may include a central processing unit (CPU), a graphics processing unit (GPU), a digital signal processing (DSP), a microcontroller (MCU), and/or a neural processing unit (NPU). The number of the processor 221 may be one or more. For example, the processor 221 may have a structure of a multi-core processor such as a dual core, a quad core, or a hexa core.

In an embodiment, the processor 221 may include various processing circuitry and/or a plurality of processors. For example, the term “processor” used in the present disclosure, including the scope of claims, may include various processing circuitry including at least one processor, and one or more of the at least one processor may be configured to perform various functions described below individually and/or collectively in a distributed manner. As used below, when “processor”, “at least one processor”, and “one or more processors” are described as being configured to perform various functions, these terms are not limited thereto and include, for example, situations in which one processor performs a portion of cited functions, and another processor(s) performs another portion of the cited functions, and also situations in which one processor can perform all of the cited functions. Additionally, the at least one processor may include, for example, a combination of processors that perform various functions listed/initiated in a distributed manner. The at least one processor may execute program instructions to achieve or perform various functions.

In an embodiment, the memory 222 of the wearable device 201 may include a hardware component for storing data and/or instructions input to the processor 221 and/or output from the processor 221. For example, the memory 222 may include volatile memory such as random-access memory (RAM) and/or non-volatile memory such as read-only memory (ROM). For example, the volatile memory may include at least one of dynamic RAM (DRAM), static RAM (SRAM), Cache RAM, and pseudo SRAM (PSRAM). The non-volatile memory may include, for example, at least one of programmable ROM (PROM), erasable PROM (EPROM), electrically erasable PROM (EEPROM), flash memory, a hard disk, a compact disk, and an embedded multimedia card (eMMC).

In an embodiment, one or more instructions (or commands) indicating a calculation and/or an operation performed by the processor 221 of the wearable device 201 may be stored in the memory 222 of the wearable device 201. A set of the one or more instructions may be referred to as a program, firmware, an operating system, a process, a routine, a sub-routine, and/or an application. Hereinafter, being installed in the wearable device 201 may refer, for example, to one or more instructions provided in a form of the application being stored in the memory 222, and one or more applications are stored in an executable format by the processor 221 of the wearable device 201.

In an embodiment, the communication circuitry 223 of the wearable device 201 may include a circuit for supporting transmission and/or reception of an electrical signal between the wearable device 201 and the electronic device 101. The communication circuitry 223 may include at least one of a modem, an antenna, and an optic/electronic (O/E) converter. The communication circuitry 223 may support the transmission and/or the reception of the electrical signal based on various types of communication means such as Ethernet, Bluetooth, Bluetooth low energy (BLE), ZigBee, long term evolution (LTE), and 5G new radio (NR).

In an embodiment, the display 224 of the wearable device 201 may include a display panel, a touch sensor, and/or processing circuitry. In an embodiment, the display panel may be used to display visual information (e.g., an image, a screen, an object, a visual object, a user interface (UI), and/or a graphic user interface (GUI).

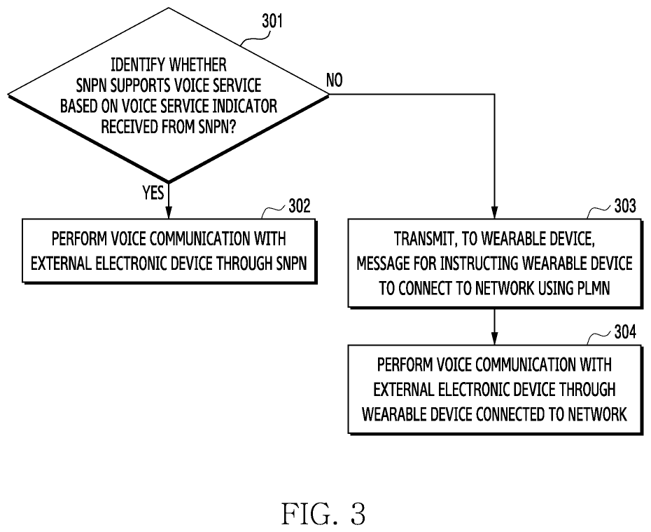

FIG. 3 is a flowchart illustrating an example operation of an electronic device for receiving a voice service through a wearable device according to various embodiments. Operations of FIG. 3 may be performed by the electronic device 101 of FIGS. 1 and 2. For example, at least a portion of the operations may be controlled by a processor 211 of the electronic device 101. Hereinafter, each operation may be sequentially performed, but is not necessarily performed sequentially. For example, an order of each operation may be changed. For example, at least two operations may be performed in parallel.

Referring to FIG. 3, in operation 301, the electronic device 101 may identify whether a SNPN 103 supports a voice service based on a voice service indicator received from the standalone non-public network (SNPN) 103.

In an embodiment, the electronic device 101 may receive (or obtain) the voice service indicator from the SNPN 103 during a registration procedure for the SNPN 103. For example, the voice service indicator may indicate whether the voice service is supported by the SNPN 103. In an example, the voice service indicator may indicate whether an internet protocol multimedia subsystem (IMS) voice over PS session is supported by the SNPN 103. For example, the electronic device 101 may identify whether the SNPN 103 supports the voice service based on the received voice indicator. In an example, the electronic device 101 may receive (or obtain) a voice service indicator from an access and mobility function (AMF) associated with the SNPN 103. However, this is simply an example, and the present disclosure is not limited thereto.

In operation 302, the electronic device 101 may perform voice communication with an external electronic device through the SNPN 103. For example, the electronic device 101 may perform the voice communication with the external electronic device through the SNPN 103 according to an identification that the SNPN 103 supports the voice service. For example, the electronic device 101 may transmit a call connection request message for requesting a call connection with the external electronic device through the SNPN 103. The electronic device 101 may receive a call connection response message through the SNPN 103 in response to the call connection request message. The electronic device 101 may perform the voice communication with the external electronic device through the SNPN 103 by establishing the call connection in response to the call connection response message. In another example, the electronic device 101 may receive a call connection request message from the external electronic device through the SNPN 103. The electronic device 101 may perform the voice communication with the external electronic device through the SNPN 103 by establishing the call connection in response to the call connection request message.

In operation 303, the electronic device 101 may transmit, to a wearable device 201, a message for instructing the wearable device 201 to connect to a network (e.g., a base station, or a core network (CN)) using a public land mobile network (PLMN) 102.

In an embodiment, the electronic device 101 may identify whether a first condition is satisfied. For example, the electronic device 101 may identify that the first condition is satisfied according to an identification that the SNPN 103 does not support the voice service. In another example, the electronic device 101 may identify that the first condition is not satisfied according to an identification that the SNPN 103 supports the voice service.

In an embodiment, the electronic device 101 may identify whether a second condition is satisfied. For example, the electronic device 101 may identify whether a connection between the electronic device 101 and the wearable device 201 is based on a first radio access technology (RAT) (e.g., Bluetooth).

For example, the wearable device 201 may be connected to the electronic device 101 through the first RAT (e.g., the Bluetooth) before receiving the message. The wearable device 201 may be configured to deactivate a second RAT (e.g., long term evolution (LTE), or new radio (NR)) while connected to the electronic device 101 through the first RAT. In an example, an operation mode of the wearable device 201 that deactivates the second RAT while the electronic device 101 and the wearable device 201 are connected through the first RAT may be referred to as a flight mode. However, this is merely an example, and the present disclosure is not limited thereto. The wearable device 201 may be set to deactivate the second RAT in the operation mode. For example, the wearable device 201 may deactivate (or turn off) at least a portion of the communication circuitry 223 of the wearable device 201 associated with the second RAT, in the operation mode. Since the at least a portion of the communication circuitry 223 of the wearable device 201 is deactivated in the operation mode, power consumption of the wearable device 201 may be reduced. However, since communication through the second RAT of the wearable device 201 is deactivated in the operation mode, the wearable device 201 cannot connect to a network of the PLMN 102 using the second RAT. Therefore, the electronic device 101 may identify whether the connection between the electronic device 101 and the wearable device 201 is a connection based on the first RAT.

For example, the electronic device 101 may identify that the second condition is satisfied according to an identification that the connection between the electronic device 101 and the wearable device 201 is the connection based on the first RAT. In another example, the electronic device 101 may identify that the second condition is not satisfied according to an identification that the connection between the electronic device 101 and the wearable device 201 is not the connection based on the first RAT.

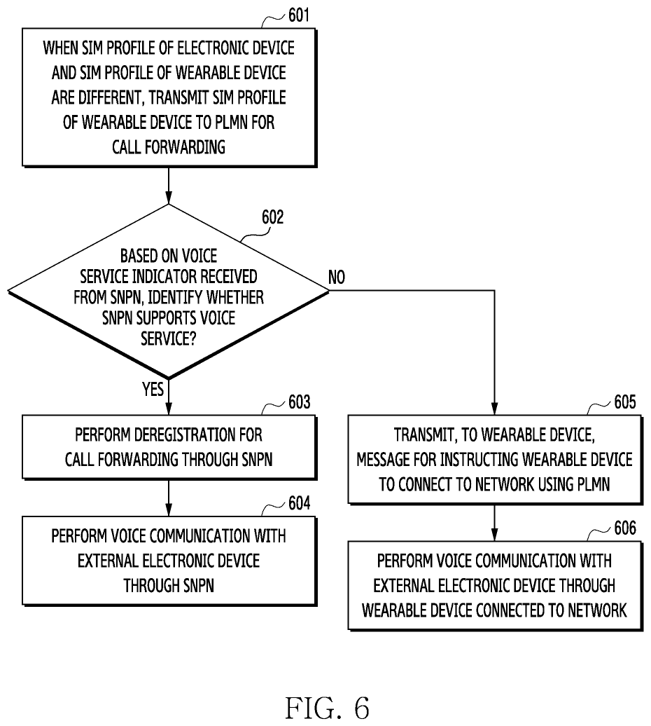

In an embodiment, the electronic device 101 may identify whether a third condition is satisfied. For example, the electronic device 101 may identify whether a subscriber identity module (SIM) profile of the electronic device 101 and a SIM profile of the wearable device 201 are identical. When the SIM profile of the electronic device 101 and the SIM profile of the wearable device 201 are different, an additional procedure (e.g., operation 601 of FIG. 6) may be required for call forwarding to the wearable device 201. Therefore, the electronic device 101 may identify whether the SIM profile of electronic device 101 and the SIM profile of wearable device 201 are identical.

For example, the electronic device 101 may identify that the third condition is satisfied according to an identification that the SIM profile of the electronic device 101 and the SIM profile of the wearable device 201 are identical. In another example, the electronic device 101 may identify that the third condition is not satisfied according to an identification that the SIM profile of the electronic device 101 and the SIM profile of the wearable device 201 are different.

In an embodiment, the electronic device 101 may transmit, to the wearable device 201, a message for instructing the wearable device 201 to connect to the network (e.g., the base station, or the core network (CN)) using the PLMN 102, according to an identification that the first condition, the second condition, and the third condition are satisfied. However, the present disclosure is not limited thereto. For example, the electronic device 101 may transmit the message to the wearable device 201 according to an identification that the first condition is satisfied. For example, the electronic device 101 may transmit the message to the wearable device 201 according to an identification that the second condition is satisfied. For example, the electronic device 101 may transmit the message to the wearable device 201 according to an identification that the third condition is satisfied. For example, the electronic device 101 may transmit the message to the wearable device 201 according to an identification that at least two of the first condition to the third conditions are satisfied. For example, the message may cause wearable device 201 to activate the second RAT. For example, the message may cause wearable device 201 to deactivate the operation mode for deactivating the second RAT. For example, the message may cause wearable device 201 to perform a registration procedure for PLMN 102 through the second RAT.

In operation 304, the electronic device 101 may perform voice communication with the external electronic device through the wearable device 201 connected to the network of the PLMN 102. For example, the electronic device 101 may transmit a call connection request message for requesting a call connection with the external electronic device to the network of PLMN 102 through wearable device 201. The electronic device 101 may receive a call connection response message through the wearable device 201 in response to the call connection request message. The electronic device 101 may perform the voice communication with the external electronic device through the wearable device 201 by establishing the call connection in response to the call connection response message. In another example, the electronic device 101 may receive a call connection request message from the external electronic device through the wearable device 201. The electronic device 101 may perform the voice communication with the external electronic device through the wearable device 201 by establishing the call connection in response to the call connection request message.

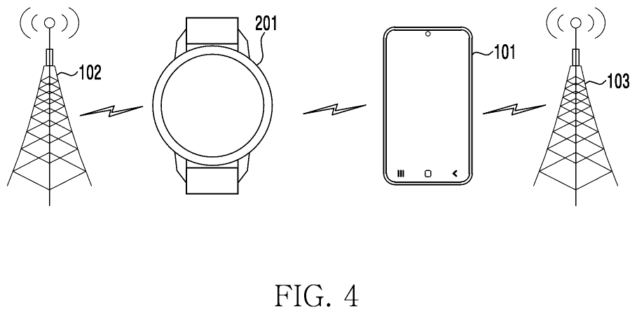

FIG. 4 is a diagram illustrating an example of receiving a voice service through a wearable device according to various embodiments.

In the example illustrated in FIG. 4, an electronic device 101 includes a single subscriber identity module (SIM). Since the electronic device 101 includes the single SIM, the electronic device 101 may be concurrently connected to a public land mobile network (PLMN) 102 and a standalone non-public network (SNPN) 103. In the example illustrated in FIG. 4, the SNPN 103 does not support a voice service.

Referring to FIG. 4, an access mode of the electronic device 101 may be changed from a PLMN access mode to a SNPN access mode. For example, the PLMN access mode may indicate a state in which the electronic device 101 is connected to the PLMN 102. For example, the SNPN access mode may indicate a state in which the electronic device 101 is connected to the SNPN 103. In an example, the electronic device 101 may change the access mode of the electronic device 101 from the PLMN access mode to the SNPN access mode, based on a user input. However, this is merely an example, and the present disclosure is not limited thereto. For example, the electronic device 101 may automatically change the access mode of the electronic device 101 from the PLMN access mode to the SNPN access mode by identifying the SNPN 103 based on a list.

The electronic device 101 may identify whether conditions for transmitting, to a wearable device 201, a message for instructing the wearable device 201 to connect to a network (e.g., a base station, or a core network (CN)) using the PLMN 102, are satisfied. The conditions may include a first condition, a second condition, and a third condition. However, this is merely an example, and the present disclosure is not limited thereto. For example, the conditions may include only a portion of the first condition, the second condition, and the third condition. For example, the electronic device 101 may identify whether the SNPN 103 supports the voice service based on a voice service indicator received from the SNPN 103 during a registration procedure for the SNPN 103. According to an identification that the SNPN 103 does not support the voice service, the electronic device 101 may identify that the first condition is satisfied. For example, the electronic device 101 may identify a radio access technology (RAT) between the electronic device 101 and the wearable device 201. The electronic device 101 may identify that the second condition is satisfied according to an identification that the identified RAT is a first RAT (e.g., Bluetooth). For example, the electronic device 101 may identify whether a SIM profile of the electronic device 101 and a SIM profile of the wearable device 201 are identical. The electronic device 101 may identify that the third condition is satisfied according to an identification that the SIM profile of the electronic device 101 and the SIM profile of the wearable device 201 are identical.

According to an identification that the conditions are satisfied, the electronic device 101 may transmit, the wearable device 201, the message for instructing the wearable device 201 to connect to the network using the PLMN 102. For example, the message may cause wearable device 201 to activate a second RAT. For example, the message may cause the wearable device 201 to deactivate an operation mode of the wearable device 201 that deactivates the second RAT. For example, the message may cause wearable device 201 to perform a registration procedure for PLMN 102 through the second RAT.

The electronic device 101 may perform voice communication with the external electronic device through the wearable device 201 connected to the network of the PLMN 102. For example, the electronic device 101 may transmit a call connection request message for requesting a call connection with the external electronic device to the network of PLMN 102 through wearable device 201. The electronic device 101 may receive a call connection response message through the wearable device 201 in response to the call connection request message. The electronic device 101 may perform the voice communication with the external electronic device through the wearable device 201 by establishing the call connection in response to the call connection response message. In another example, the electronic device 101 may receive a call connection request message from the external electronic device through the wearable device 201. The electronic device 101 may perform voice communication with the external electronic device through the wearable device 201 by establishing the call connection in response to the call connection request message.

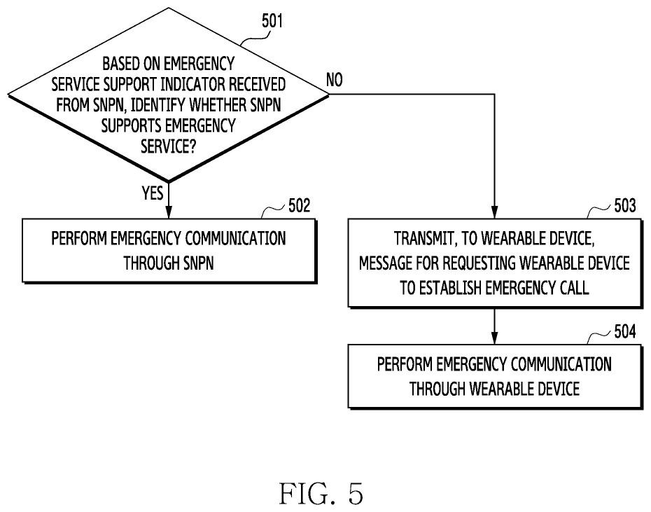

FIG. 5 is a flowchart illustrating an example operation of an electronic device for performing emergency communication through a wearable device according to various embodiments. Operations of FIG. 5 may be performed by the electronic device 101 of FIGS. 1 and 2. For example, at least a portion of the operations may be controlled by a processor 211 of the electronic device 101. Hereinafter, each operation may be sequentially performed, but is not necessarily performed sequentially. For example, an order of each operation may be changed. For example, at least two operations may be performed in parallel. For example, the operations of the electronic device 101 illustrated in FIG. 5 may be performed subsequent to or in parallel with the operations of FIG. 3.

Referring to FIG. 5, in operation 501, based on an emergency service support indicator received from a standalone non-public network 103, the electronic device 101 may identify whether the SNPN 103 supports an emergency service.

In an embodiment, the electronic device 101 may receive (or obtain) the emergency service support indicator from the SNPN 103 during a registration procedure for the SNPN 103. For example, the emergency service support indicator may indicate whether the SNPN 103 supports an emergency call. For example, the electronic device 101 may identify whether the SNPN 103 supports the emergency service based on the received emergency service support indicator.

In operation 502, the electronic device 101 may perform emergency communication through the SNPN 103. For example, the electronic device 101 may perform the emergency communication through the SNPN 103 according to an identification that the SNPN 103 supports the emergency service. For example, the electronic device 101 may perform the emergency communication through the SNPN 103 based on a user input requesting the emergency call.

In operation 503, the electronic device 101 may transmit, to a wearable device 201, a message for requesting the wearable device 201 to establish the emergency call. For example, the electronic device 101 may transmit, to the wearable device 201, the message for requesting the wearable device 201 to establish the emergency call, according to an identification that the SNPN 103 does not support the emergency service. For example, the message may cause wearable device 201 to establish the emergency call using a network of a public land mobile network (PLMN) 102.

In operation 504, the electronic device 101 may perform the emergency communication through the wearable device 201. For example, when the emergency call is established by the wearable device 201, the electronic device 101 may perform the emergency communication through the wearable device 201.

FIG. 6 is a flowchart illustrating an example operation of an electronic device associated with call forwarding according to various embodiments. Operations of FIG. 6 may be performed by the electronic device 101 of FIGS. 1 and 2. For example, at least a portion of each operation may be controlled by a processor 211 of the electronic device 101. Hereinafter, each operation may be sequentially performed, but is not necessarily performed sequentially. For example, an order of each operation may be changed. For example, at least two operations may be performed in parallel.

Referring to FIG. 6, in operation 601, when a subscriber identity module (SIM) profile of the electronic device 101 and a SIM profile of a wearable device 201 are different, the electronic device 101 may transmit the SIM profile of the wearable device 201 to a PLMN 102 for call forwarding.

In an embodiment, the electronic device 101 may identify whether the SIM profile of the electronic device 101 and the SIM profile of the wearable device 201 are identical in a PLMN access mode. For example, when the SIM profile of the electronic device 101 and the SIM profile of the wearable device 201 are different, a call request from the PLMN 102 may not be received by the wearable device 201.

In an embodiment, the electronic device 101 may transmit the SIM profile of the wearable device 201 to the PLMN 102 for call forwarding, according to an identification that the SIM profile of the electronic device 101 and the SIM profile of the wearable device 201 are different. For example, by transmitting the SIM profile of the wearable device 201 to the PLMN 102 for the call forwarding, a call with respect to the electronic device 101 may be redirected to a call with respect to the wearable device 201.

In operation 602, based on a voice service indicator received from a standalone non-public network (SNPN) 103, the electronic device 101 may identify whether the SNPN 103 supports a voice service.

In an embodiment, the electronic device 101 may receive (or obtain) the voice service indicator from the SNPN 103 during a registration procedure for the SNPN 103 for changing an access mode of the electronic device 101 from the PLMN access mode to a SNPN access mode. For example, the voice service indicator may indicate whether the voice service is supported by the SNPN 103. In an example, the voice service indicator may indicate whether an internet protocol multimedia subsystem (IMS) voice over PS session is supported by the SNPN 103. However, this is merely an example, and the present disclosure is not limited thereto. In an example, the electronic device 101 may receive (or obtain) a voice service indicator from an access and mobility function (AMF) associated with the SNPN 103. However, this is merely an example, and the present disclosure is not limited thereto.

In operation 603, the electronic device 101 may perform deregistration for the call forwarding through the SNPN 103. In an embodiment, the electronic device 101 may perform the deregistration for the call forwarding through the SNPN 103, according to an identification that the SNPN 103 supports the voice service. For example, since the electronic device 101 may perform voice communication with an external electronic device through the SNPN 103 without the call forwarding, the electronic device 101 may perform the deregistration for the call forwarding.

In operation 604, the electronic device 101 may perform the voice communication with the external electronic device through the SNPN 103. For example, the electronic device 101 may transmit a call connection request message for requesting a call connection with the external electronic device through the SNPN 103. The electronic device 101 may receive a call connection response message through the SNPN 103 in response to the call connection request message. The electronic device 101 may perform the voice communication with the external electronic device through the SNPN 103 by establishing the call connection in response to the call connection response message. In another example, the electronic device 101 may receive a call connection request message from the external electronic device through the SNPN 103. The electronic device 101 may perform the voice communication with the external electronic device through the SNPN 103 by establishing the call connection in response to the call connection request message.

In operation 605, the electronic device 101 may transmit, to the wearable device 201, a message for instructing the wearable device 201 to connect to a network (e.g., a base station, or a core network (CN)) using the PLMN 102.

In an embodiment, the electronic device 101 may identify whether a first condition is satisfied. For example, the electronic device 101 may identify that the first condition is satisfied according to an identification that the SNPN 103 does not support the voice service. In another example, the electronic device 101 may identify that the first condition is not satisfied according to an identification that the SNPN 103 supports the voice service.

In an embodiment, the electronic device 101 may identify whether a second condition is satisfied. For example, the electronic device 101 may identify whether a connection between the electronic device 101 and the wearable device 201 is a connection based on a first radio access technology (RAT) (e.g., Bluetooth).

For example, the wearable device 201 may be connected to the electronic device 101 through the first RAT (e.g., the Bluetooth) before receiving the message. The wearable device 201 may be configured to deactivate a second RAT (e.g., long term evolution (LTE), or new radio (NR)) while connected to the electronic device 101 through the first RAT. In an example, the operation mode of the wearable device 201 that deactivates the second RAT while the electronic device 101 and the wearable device 201 are connected through the first RAT may be referred to as a flight mode. However, this is merely an example, and the present disclosure is not limited thereto. The wearable device 201 may be set to deactivate the second RAT in the operation mode. For example, the wearable device 201 may deactivate (or turn off) at least a portion of communication circuitry 223 of the wearable device 201 associated with the second RAT, in the operation mode. Since the at least a portion of the communication circuitry 223 of the wearable device 201 is deactivated in the operation mode, power consumption of the wearable device 201 may be reduced. However, since communication through the second RAT of the wearable device 201 is deactivated in the operation mode, the wearable device 201 cannot connect to a network of the PLMN 102 using the second RAT. Therefore, the electronic device 101 may identify whether the connection between the electronic device 101 and the wearable device 201 is the connection based on the first RAT.

For example, the electronic device 101 may identify that the second condition is satisfied according to an identification that the connection between the electronic device 101 and the wearable device 201 is the connection based on the first RAT. In another example, the electronic device 101 may identify that the second condition is not satisfied according to an identification that the connection between the electronic device 101 and the wearable device 201 is not the connection based on the first RAT.

In an embodiment, the electronic device 101 may identify whether a third condition is satisfied. For example, the electronic device 101 may identify whether a subscriber identity module (SIM) profile of the electronic device 101 and a SIM profile of the wearable device 201 are identical. When the SIM profile of the electronic device 101 and the SIM profile of the wearable device 201 are different, an additional procedure (e.g., the operation 601 of FIG. 6) may be required for call forwarding to the wearable device 201. Therefore, the electronic device 101 may identify whether the SIM profile of electronic device 101 and the SIM profile of the wearable device 201 are identical.

For example, the electronic device 101 may identify that the third condition is satisfied according to an identification that the SIM profile of the electronic device 101 and the SIM profile of the wearable device 201 are identical. In another example, the electronic device 101 may identify that the third condition is not satisfied according to an identification that the SIM profile of the electronic device 101 and the SIM profile of the wearable device 201 are different.

In an embodiment, the electronic device 101 may transmit, to the wearable device 201, a message for instructing the wearable device 201 to connect to the network (e.g., a base station, or a core network (CN)) using the PLMN 102, according to the identification that the first condition, the second condition, and the third condition are satisfied. However, the present disclosure is not limited thereto. For example, the electronic device 101 may transmit the message to the wearable device 201 according to an identification that the first condition is satisfied. For example, the electronic device 101 may transmit the message to the wearable device 201 according to an identification that the second condition is satisfied. For example, the electronic device 101 may transmit the message to the wearable device 201 according to an identification that the third condition is satisfied. For example, the electronic device 101 may transmit the message to the wearable device 201 according to an identification that at least two of the first condition to the third condition are satisfied. For example, the message may cause the wearable device 201 to activate the second RAT. For example, the message may cause wearable device 201 to deactivate an operation mode for deactivating the second RAT. For example, the message may cause wearable device 201 to perform a registration procedure for PLMN 102 through the second RAT.

In operation 606, the electronic device 101 may perform the voice communication with the external electronic device through the wearable device 201 connected to the network of the PLMN 102. For example, the electronic device 101 may transmit a call connection request message for requesting a call connection with the external electronic device to the network of the PLMN 102 through the wearable device 201. The electronic device 101 may receive a call connection response message through the wearable device 201 in response to the call connection request message. The electronic device 101 may perform the voice communication with the external electronic device through the wearable device 201 by establishing the call connection in response to the call connection response message. In another example, the electronic device 101 may receive a call connection request message from the external electronic device through the wearable device 201. The electronic device 101 may perform the voice communication with the external electronic device through the wearable device 201 by establishing the call connection in response to the call connection request message.

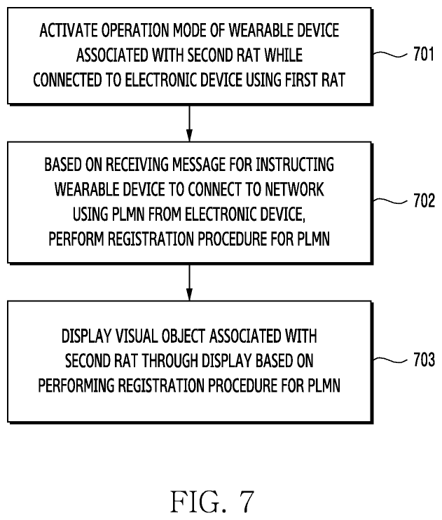

FIG. 7 is a flowchart illustrating an example operation of a wearable device for providing a voice service to an electronic device. Operations of FIG. 7 may be performed by the wearable device 201 of FIG. 2. For example, at least a portion of the operations of FIG. 7 may be controlled by a processor 221 of the wearable device 201. Hereinafter, each operation may be sequentially performed, but is not necessarily performed sequentially. For example, an order of each operation may be changed. For example, at least two operations may be performed in parallel.

Referring to FIG. 7, in operation 701, the wearable device 201 may activate an operation mode of the wearable device 201 associated with a second RAT (e.g., long term evolution (LTE), or new radio (NR)) while connected to an electronic device 101 through a first RAT (e.g., Bluetooth).

In an embodiment, the wearable device 201 may be connected to the electronic device 101 through the first RAT. The wearable device 201 may be set to deactivate the second RAT while connected to the electronic device 101 through the first RAT. In an example, an operation mode of the wearable device 201 that deactivates the second RAT while the electronic device 101 and the wearable device 201 are connected through the first RAT may be referred to as a flight mode. However, this is merely an example, and the present disclosure is not limited thereto. The wearable device 201 may be set to deactivate the second RAT in the operation mode. For example, the wearable device 201 may deactivate (or turn off) at least a portion of communication circuitry 223 of the wearable device 201 associated with the second RAT, in the operation mode. Since the at least a portion of the communication circuitry 223 of the wearable device 201 is deactivated in the operation mode, power consumption of the wearable device 201 may be reduced.

In operation 702, based on receiving a message for instructing the wearable device 201 to connect to a network using a PLMN 102, the wearable device 201 may perform a registration procedure for the PLMN.

In an embodiment, the wearable device 201 may receive (or obtain), from the electronic device 101, a message instructing the wearable device 201 to connect to a network (e.g., a base station, or a core network (CN)) using the PLMN 102, using the first RAT. The wearable device 201 may activate the second RAT based on the message. For example, the wearable device 201 may deactivate the operation mode of the wearable device 201 that deactivates the second RAT, based on the message. For example, the wearable device 201 may activate (or turn-on) the at least a portion of the communication circuitry 223 of the wearable device 201 associated with the second RAT, based on the message. For example, the wearable device 201 may perform a registration procedure for the PLMN 102.

In operation 703, the wearable device 201 may display a visual object associated with the second RAT through a display 224 based on performing the registration procedure for the PLMN 102.

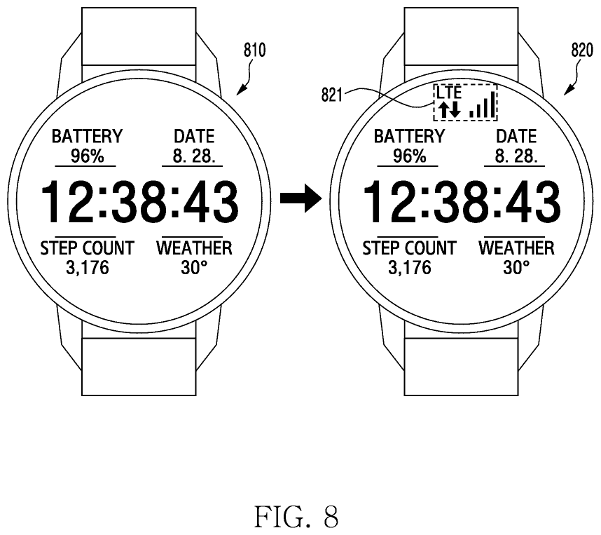

FIG. 8 is a diagram illustrating an example screen of a display of a wearable device providing a voice service to an electronic device according to various embodiments.

Referring to FIG. 8, a wearable device 201 may be configured to deactivate a second RAT (e.g., long term evolution (LTE), or new radio (NR)) while connected to an electronic device 101 through a first RAT (e.g., Bluetooth). For example, an operation mode of the wearable device 201 that deactivates the second RAT while the wearable device 201 and the electronic device 101 are connected through the first RAT may be referred to as a flight mode. However, this is merely an example, and the present disclosure is not limited thereto. For example, the wearable device 201 may not display a visual object associated with the second RAT on a screen of a display 224, based on deactivating the second RAT.

The wearable device 201 may receive (or obtain), from the electronic device 101, a message for instructing the wearable device 201 to connect to a network (e.g., a base station, or a core network (CN)) using a PLMN 102. The wearable device 201 may activate the second RAT based on the message. For example, the wearable device 201 may deactivate the operation mode of the wearable device 201 that deactivates the second RAT, based on the message. For example, the wearable device 201 may activate (or turn-on) at least a portion of communication circuitry 223 of the wearable device 201 associated with the second RAT, based on the message. The wearable device 201 may perform a registration procedure for the PLMN 102 using the second RAT. Based on activating the second RAT, the wearable device 201 may display a visual object 821 associated with the second RAT on the screen of the display 224 of the wearable device 201.

As described above, when the electronic device 101 is connected to a SNPN 103, the screen of the display 224 of the wearable device 201 may be changed without a direct input of a user with respect to the wearable device 201.

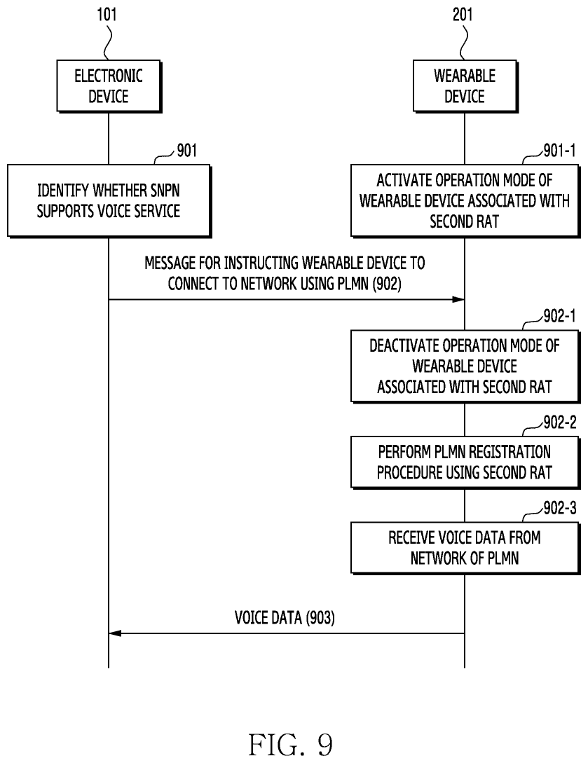

FIG. 9 is a signal flow diagram illustrating example signaling between an electronic device and a wearable device for providing a voice service according to various embodiments. Operations of FIG. 9 may be performed by the electronic device 101 and/or the wearable device 201 of FIG. 2. Hereinafter, each operation may be sequentially performed, but is not necessarily performed sequentially. For example, an order of each operation may be changed. For example, at least two operations may be performed in parallel.

Referring to FIG. 9, in operation 901, the electronic device 101 may identify whether a standalone non-public network (SNPN) 103 supports a voice service.

In an embodiment, the electronic device 101 may receive (or obtain) a voice service indicator from the SNPN 103 during a registration procedure for the SNPN 103. In an example, the electronic device 101 may receive (or obtain) a voice service indicator from an access and mobility function (AMF) associated with the SNPN 103. However, this is merely an example, and the present disclosure is not limited thereto. However, the present disclosure is not limited thereto. For example, the voice service indicator may indicate whether the voice service is supported by the SNPN 103. In an example, the voice service indicator may indicate whether an internet protocol multimedia subsystem (IMS) voice over PS session is supported by the SNPN 103. However, the present disclosure is not limited thereto. For example, the electronic device 101 may identify whether the SNPN 103 supports the voice service based on the received voice indicator. For example, according to an identification that the SNPN 103 does not support the voice service, the electronic device 101 may identify that a first condition for transmitting a message is satisfied. In another example, according to an identification that the SNPN 103 supports the voice service, the electronic device 101 may identify that the first condition for transmitting the message is satisfied.

In an embodiment, the electronic device 101 may identify whether a connection between the electronic device 101 and the wearable device 201 is a connection based on a first radio access technology (RAT) (e.g., Bluetooth). For example, the electronic device 101 may identify that a second condition for transmitting the message is satisfied, according to an identification that the connection between the electronic device 101 and the wearable device 201 is the connection based on the first RAT. In another example, the electronic device 101 may identify that the second condition for transmitting the message is not satisfied according to an identification that the connection between the electronic device 101 and the wearable device 201 is not the connection based on the first RAT.

In an embodiment, the electronic device 101 may identify whether a subscriber identity module (SIM) profile of the electronic device 101 and a SIM profile of the wearable device 201 are identical. For example, the electronic device 101 may identify that a third condition for transmitting the message is satisfied, according to an identification that the SIM profile of the electronic device 101 and the SIM profile of the wearable device 201 are identical. In another example, the electronic device 101 may identify that the third condition for transmitting the message is not satisfied according to an identification that the SIM profile of the electronic device 101 and the SIM profile of the wearable device 201 are different.

In operation 902, the electronic device 101 may transmit a message for instructing the wearable device 201 to connect to a network (e.g., a base station, or a core network (CN)) using a PLMN 102.

In an embodiment, the electronic device 101 may transmit, to the wearable device 201, the message for instructing the wearable device 201 to connect to the network using the PLMN 102 according to an identification that a first condition, a second condition, and a third condition are satisfied. However, the present disclosure is not limited thereto. For example, the electronic device 101 may transmit the message to the wearable device 201 according to an identification that the first condition is satisfied. For example, the electronic device 101 may transmit the message to the wearable device 201 according to an identification that the second condition is satisfied. For example, the electronic device 101 may transmit the message to the wearable device 201 according to an identification that the third condition is satisfied. For example, the electronic device 101 may transmit the message to the wearable device 201 according to an identification that at least two of the first condition to the third condition are satisfied. For example, the message may cause wearable device 201 to activate the second RAT. For example, the message may cause wearable device 201 to deactivate an operation mode for deactivating the second RAT. For example, the message may cause wearable device 201 to perform a registration procedure for PLMN 102 through the second RAT.

In operation 903, the electronic device 101 may perform voice communication with an external electronic device by receiving voice data from the wearable device 201.

Referring to FIG. 9, in operation 901-1, the wearable device 201 may activate an operation mode of the wearable device 201 associated with the second RAT (e.g., LTE, or NR) while connected to the electronic device 101 through the first RAT (e.g., the Bluetooth).

In an embodiment, the wearable device 201 may be connected to the electronic device 101 through the first RAT. The wearable device 201 may be set to deactivate the second RAT while connected to the electronic device 101 through the first RAT. In an example, an operation mode of the wearable device 201 that deactivates the second RAT while the electronic device 101 and the wearable device 201 are connected through the first RAT may be referred to as a flight mode. However, this is merely an example, and the present disclosure is not limited thereto. The wearable device 201 may be set to deactivate the second RAT, in the operation mode. For example, the wearable device 201 may deactivate (or turn off) at least a portion of communication circuitry 223 of the wearable device 201 associated with the second RAT, in the operation mode. Since the at least a portion of the communication circuitry 223 of the wearable device 201 is deactivated in the operation mode, power consumption of the wearable device 201 may be reduced.

In operation 902, the wearable device 201 may receive the message for instructing the wearable device 201 to connect to the network using the PLMN 102. For example, the wearable device 201 may receive (or obtain), from the electronic device 101, the message for instructing the wearable device 201 to connect with the network using the PLMN 102, using the first RAT.

In operation 902-1, the wearable device may deactivate the operation mode of the wearable device 201 associated with the second RAT. For example, the operation mode may refer, for example, to a mode for deactivating the second RAT while the wearable device 201 and the electronic device 101 are connected through the first RAT. For example, the wearable device 201 may activate the second RAT by deactivating the operation mode. For example, the wearable device 201 may activate the at least a portion of the communication circuitry 223 of the wearable device 201 associated with the second RAT.

In operation 902-2, the wearable device 201 may perform a PLMN registration procedure using the second RAT. For example, in a PLMN access mode, the wearable device 201 may display a visual object associated with the second RAT on a screen of a display 224 of the wearable device 201.

In operation 902-3, the wearable device 201 may receive voice data from the network of the PLMN 102 using the second RAT. For example, the wearable device 201 may cause a call connection between the electronic device 101 and the external electronic device by transmitting a call connection request message received from the network to the electronic device 101. In another example, the wearable device 201 may cause the call connection between the electronic device 101 and the external electronic device, by transmitting a call connection request message received from the electronic device 101 to the network of the PLMN 102. The wearable device 201 may receive the voice data from the network of the PLMN 102 using the second RAT.

In operation 903, the wearable device 201 may transmit the voice data received (or obtained) from the network of the PLMN 102 to the electronic device 101 using the first RAT.

The technical problems addressed in the present disclosure are not limited to those mentioned above, and other technical problems not mentioned will be clearly understood by those of ordinary skill in the art to which the present disclosure belongs.

As described above, according to an example embodiment, an electronic device may comprise communication circuitry. The electronic device may comprise memory, including one or more storage media, storing instructions. The electronic device may comprise at least one processor including processing circuitry. The instructions, when executed by the at least one processor individually or collectively, may cause the electronic device to: identify whether a standalone non-public network (SNPN) supports a voice service, based on a voice service indicator received from the SNPN during a registration procedure for the SNPN; transmit, to a wearable device, a message instructing the wearable device connected to the electronic device through a first radio access technology (RAT) to connect to a network using a public land mobile network (PLMN) in accordance with an identification that the SNPN does not support the voice service; and perform a voice communication with an external electronic device through the wearable device connected to the network.

For example, the instructions, when executed by the at least one processor individually or collectively, may cause the electronic device to: identify whether the SNPN supports an emergency service, based on an emergency service support indicator received from the SNPN during the registration procedure for the SNPN; transmit, to the wearable device, a message for requesting the wearable device to establish an emergency call in response to a user input requesting the emergency call in accordance with an identification that the SNPN does not support the emergency service; and perform an emergency communication through the wearable device.

For example, the message for instructing the wearable device to connect to the network using the PLMN may include information requesting an activation of a second RAT for connecting to the network of the PLMN.

For example, the instructions, when executed by the at least one processor individually or collectively, may cause the electronic device to: identify whether a subscriber identity module (SIM) profile of the electronic device and a SIM profile of the wearable device are identical in a PLMN access mode; and transmit, to the PLMN, the SIM profile of the wearable device for call forwarding in accordance with an identification that the SIM profile of the electronic device and the SIM profile of the wearable device are different.

For example, the instructions, when executed by the at least one processor individually or collectively, may cause the electronic device to perform deregistration for the call forwarding through the SNPN in accordance with an identification that the SNPN supports the voice service after changing from the PLMN access mode to a SNPN access mode.

For example, the instructions, when executed by the at least one processor individually or collectively, may cause the electronic device to transmit, to the wearable device, a message including information requesting a deactivation of a second RAT for connecting to the network of the PLMN based on identifying that an access mode of the electronic device is changed from a SNPN access mode to a PLMN access mode.

For example, the instructions, when executed by the at least one processor individually or collectively, may cause the electronic device to: identify whether a SIM profile of the electronic device and a SIM profile of the wearable device are identical; identify whether an operation mode of the wearable device deactivating a second RAT for connecting to the network of the PLMN is activated; and transmit, to the wearable device, the message for instructing the wearable device to connect to the network using the PLMN in accordance with an identification that the SIM profile of the electronic device and the SIM profile of the wearable device are identical and an identification that the operation mode of the wearable device deactivating the second RAT is activated.

For example, the electronic device may include a single SIM.

As described above, according to an example embodiment, a method performed by an electronic device including communication circuitry may comprise: identifying whether a standalone non-public network (SNPN) supports a voice service based on a voice service indicator received from the SNPN during a registration procedure for the SNPN; transmitting, to a wearable device, a message instructing the wearable device connected to the electronic device through a first radio access technology (RAT) to connect to a network using a public land mobile network (PLMN) in accordance an identification that the SNPN does not support the voice service; and performing a voice communication with an external electronic device through the wearable device connected to the network.

For example, the method may comprise: identifying whether the SNPN supports an emergency service based on an emergency service support indicator received from the SNPN during the registration procedure for the SNPN; transmitting, to the wearable device, a message for requesting the wearable device to establish an emergency call in response to a user input requesting the emergency call in accordance with an identification that the SNPN does not support the emergency service; and performing an emergency communication through the wearable device.

For example, the message for instructing the wearable device to connect to the network using the PLMN may include information requesting an activation of a second RAT for connecting with the network of the PLMN.

For example, the method may comprise: identifying whether a subscriber identity module (SIM) profile of the electronic device and a SIM profile of the wearable device are identical in a PLMN access mode; and transmitting, to the PLMN, the SIM profile of the wearable device for call forwarding in accordance with an identification that the SIM profile of the electronic device and the SIM profile of the wearable device are different.

For example, the method may comprise performing deregistration for the call forwarding through the SNPN in accordance with an identification that the SNPN supports the voice service after changing from the PLMN access mode to a SNPN access mode.

For example, the method may comprise transmitting, to the wearable device, a message including information requesting a deactivation of a second RAT for connecting to the network of the PLMN based on identifying that an access mode of the electronic device is changed from a SNPN access mode to a PLMN access mode.

For example, the method may comprise: identifying whether a SIM profile of the electronic device and a SIM profile of the wearable device are identical; identifying whether an operation mode of the wearable device deactivating a second RAT for connecting to the network of the PLMN is activated; and transmitting, to the wearable device, the message for instructing the wearable device to connect to the network using the PLMN in accordance with an identification that the SIM profile of the electronic device and the SIM profile of the wearable device are identical and an identification that the operation mode of the wearable device deactivating the second RAT is activated.

For example, the electronic device may include a single SIM.

As described above, a wearable device may comprise a display. The wearable device may comprise communication circuitry. The wearable device may comprise memory, including one or more storage media, storing instructions. The wearable device may comprise at least one processor including processing circuitry. The instructions, when executed by the at least one processor individually or collectively, may cause the wearable device to: activate an operation mode of the wearable device deactivating a second radio access technology (RAT) for connecting to a network of a public land mobile network (PLMN) while the wearable device is connected to an electronic device using a first RAT; perform a registration procedure for the PLMN based on receiving a message, from the electronic device, instructing the wearable device to connect to the network using the PLMN; and display a visual object for the operation mode of the wearable device deactivating the second RAT through the display based on performing the registration procedure for the PLMN.

For example, at least one processor individually or collectively, may be configured to cause the wearable device to establish an emergency call through the network of the PLMN in response to receiving a message, from the electronic device, requesting the wearable device to establish the emergency call.

For example, the message instructing the wearable device to connect to the network using the PLMN may include information requesting an activation of the second RAT for connecting to the network of the PLMN.

For example, a SIM profile of the wearable device may be identical to a SIM profile of the wearable device.

An electronic device according to the present disclosure may receive a voice service through a wearable device while the electronic device connects to a standalone non-public network (SNPN) in which the voice service is not supported. The electronic device according to the present disclosure may receive an emergency service through the wearable device while the electronic device connects to an SNPN in which the emergency service is not supported.

The effects that can be obtained from the present disclosure are not limited to those described above, and any other effects not mentioned herein will be clearly understood by those having ordinary skill in the art to which the present disclosure belongs.

Methods according to various embodiments of the present disclosure may be implemented as a form of hardware, software, or a combination of hardware and software.

In a case of implementing as software, a computer-readable storage medium for storing one or more programs (software module) may be provided. The one or more programs stored in the computer-readable storage medium are configured for execution by one or more processors in an electronic device. The one or more programs include instructions that, when executed, cause the electronic device to execute the methods according to various example embodiments of the present disclosure. The one or more programs may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. In the case of being distributed online, at least part of the computer program product may be temporarily generated or at least temporarily stored in the machine-readable storage medium, such as memory of the manufacturer's server, the application store's server, or a relay server.

Such a program (software module, software) may be stored in a random access memory, a non-volatile memory including a flash memory, a read only memory (ROM), an electrically erasable programmable read only memory (EEPROM), a magnetic disc storage device, a compact disc-ROM (CD-ROM), an optical storage device (digital versatile discs (DVDs) or other formats), or a magnetic cassette. It may be stored in memory configured with a combination of some or all of them. In addition, a plurality of configuration memories may be included.

Additionally, a program may be stored in an attachable storage device that may be accessed through a communication network such as the Internet, Intranet, local area network (LAN), wide area network (WAN), or storage area network (SAN), or a combination thereof. Such a storage device may be connected to a device performing an embodiment of the present disclosure through an external port. In addition, a separate storage device on the communication network may also be connected to a device performing an embodiment of the present disclosure.

In the above-described example embodiments of the present disclosure, components included in the disclosure are expressed in the singular or plural according to the presented specific embodiment. However, the singular or plural expression is selected appropriately according to a situation presented for convenience of explanation, and the present disclosure is not limited to the singular or plural component, and even components expressed in the plural may be configured in the singular, or a component expressed in the singular may be configured in the plural.

According to various embodiments, one or more components or operations of the above-described components may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be executed sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device, comprising:
communication circuitry;
memory, including one or more storage media, storing instructions; and
at least one processor including processing circuitry,
wherein the instructions, when executed by the at least one processor individually or collectively, cause the electronic device to:
identify whether a standalone non-public network (SNPN) supports a voice service based on a voice service indicator received from the SNPN during a registration procedure for the SNPN,
transmit, to a wearable device, a message instructing the wearable device connected to the electronic device through a first radio access technology (RAT) to connect to a network using a public land mobile network (PLMN) in accordance with an identification that the SNPN does not support the voice service, and
perform a voice communication with an external electronic device through the wearable device connected to the network.

2. The electronic device of claim 1,
wherein the instructions, when executed by the at least one processor individually or collectively, cause the electronic device to:
identify whether the SNPN supports an emergency service based on an emergency service support indicator received from the SNPN during the registration procedure for the SNPN,
transmit, to the wearable device, a message requesting the wearable device to establish an emergency call in response to an input requesting the emergency call in accordance with an identification that the SNPN does not support the emergency service, and
perform an emergency communication through the wearable device.

3. The electronic device of claim 1,
wherein the message instructing the wearable device to connect to the network using the PLMN includes information requesting an activation of a second RAT for connecting to the network of the PLMN.

4. The electronic device of claim 1,
wherein the instructions, when executed by the at least one processor individually or collectively, cause the electronic device to:
identify whether a subscriber identity module (SIM) profile of the electronic device and a SIM profile of the wearable device are identical in a PLMN access mode, and
transmit, to the PLMN, the SIM profile of the wearable device for call forwarding in accordance with an identification that the SIM profile of the electronic device and the SIM profile of the wearable device are different.

5. The electronic device of claim 4,
wherein the instructions, when executed by the at least one processor individually or collectively, cause the electronic device to:
perform deregistration for the call forwarding through the SNPN in accordance with an identification that the SNPN supports the voice service based on changing from the PLMN access mode to a SNPN access mode.

6. The electronic device of claim 1,
wherein the instructions, when executed by the at least one processor individually or collectively, cause the electronic device to:
transmit, to the wearable device, a message including information requesting a deactivation of a second RAT for connecting to the network of the PLMN based on identifying that an access mode of the electronic device is changed from a SNPN access mode to a PLMN access mode.

7. The electronic device of claim 1,
wherein the instructions, when executed by the at least one processor individually or collectively, cause the electronic device to:
identify whether a SIM profile of the electronic device and a SIM profile of the wearable device are identical,
identify whether an operation mode of the wearable device deactivating a second RAT for connecting to the network of the PLMN is activated, and
transmit, to the wearable device, the message instructing the wearable device to connect to the network using the PLMN in accordance with an identification that the SIM profile of the electronic device and the SIM profile of the wearable device are identical and an identification that the operation mode of the wearable device deactivating the second RAT is activated.

8. The electronic device of claim 1,
wherein the electronic device includes a single SIM.

9. A method performed by an electronic device including communication circuitry, comprising:
identifying whether a standalone non-public network (SNPN) supports a voice service based on a voice service indicator received from the SNPN during a registration procedure for the SNPN,
transmitting, to a wearable device, a message instructing the wearable device connected to the electronic device through a first radio access technology (RAT) to connect to a network using a public land mobile network (PLMN) in accordance with an identification that the SNPN does not support the voice service, and
performing a voice communication with an external electronic device through the wearable device connected to the network.

10. The method of claim 9, further comprising:
identifying whether the SNPN supports an emergency service based on an emergency service support indicator received from the SNPN during the registration procedure for the SNPN,
transmitting, to the wearable device, a message requesting the wearable device to establish an emergency call in response to an input requesting the emergency call in accordance with an identification that the SNPN does not support the emergency service, and
performing an emergency communication through the wearable device.

11. The method of claim 9,
wherein the message instructing the wearable device to connect to the network using the PLMN includes information requesting an activation of a second RAT for connecting with the network of the PLMN.

12. The method of claim 9, further comprising:
identifying whether a subscriber identity module (SIM) profile of the electronic device and a SIM profile of the wearable device are identical in a PLMN access mode, and
transmitting, to the PLMN, the SIM profile of the wearable device for call forwarding in accordance with an identification that the SIM profile of the electronic device and the SIM profile of the wearable device are different.

13. The method of claim 12, further comprising:
performing deregistration for the call forwarding through the SNPN in accordance with an identification that the SNPN supports the voice service after changing from the PLMN access mode to a SNPN access mode.

14. The method of claim 9, further comprising:
transmitting, to the wearable device, a message including information requesting a deactivation of a second RAT for connecting to the network of the PLMN based on identifying that an access mode of the electronic device is changed from a SNPN access mode to a PLMN access mode.

15. The method of claim 9, further comprising:
identifying whether a SIM profile of the electronic device and a SIM profile of the wearable device are identical,
identifying whether an operation mode of the wearable device deactivating a second RAT for connecting to the network of the PLMN is activated, and
transmitting, to the wearable device, the message instructing the wearable device to connect to the network using the PLMN in accordance with an identification that the SIM profile of the electronic device and the SIM profile of the wearable device are identical and an identification that the operation mode of the wearable device deactivating the second RAT is activated.

16. The method of claim 9,
wherein the electronic device includes a single SIM.

17. A wearable device, comprising:
a display;
communication circuitry;
memory, including one or more storage media, storing instructions; and
at least one processor including processing circuitry,
wherein the instructions, when executed by the at least one processor individually or collectively, cause the electronic device to:
activate an operation mode of the wearable device deactivating a second radio access technology (RAT) for connecting to a network of a public land mobile network (PLMN) while the wearable device is connected to the electronic device using a first RAT,
perform a registration procedure for the PLMN based on receiving a message, from the electronic device, instructing the wearable device to connect to the network using the PLMN, and
display a visual object for the operation mode of the wearable device deactivating the second RAT through the display based on performing the registration procedure for the PLMN.

18. The wearable device of claim 17,
wherein the instructions, when executed by the at least one processor individually or collectively, cause the electronic device to:
establish an emergency call through the network of the PLMN in response to receiving a message, from the electronic device, requesting the wearable device to establish the emergency call.

19. The wearable device of claim 17,
wherein the message instructing the wearable device to connect to the network using the PLMN includes information requesting an activation of the second RAT for connecting to the network of the PLMN.

20. The wearable device of claim 17,
wherein a SIM profile of the wearable device is identical to a SIM profile of the wearable device.
